(19) United States
(12) Patent Application Publication
(10) Pub. No.: US 2026/0181008 A1
(43) Pub. Date: Jun. 25, 2026

(54) THREAT AND RISK DETECTION FROM DOMAIN-LEVEL CLOUD CONTENT ITEMS

(71) Applicant: Material Security Inc., San Francisco, CA (US)

(72) Inventors: John Glenn Hrvatin, Valley Village, CA (US); Abhishek Agrawal, San Francisco, CA (US); Riley Allan Hoonan, Seattle, WA (US); Walter Kim, San Francisco, CA (US)

(21) Appl. No.: 18/988,589

(22) Filed: Dec. 19, 2024

(51) Int. Cl. H04L 9/40

(52) U.S. Cl. CPC H04L 63/1433; H04L 63/1441

(57) ABSTRACT

Systems and methods are disclosed herein for identifying security vulnerabilities within a domain. In an embodiment, a security application accesses logs of activity performed with respect to cloud content items within the domain and determines, using a plurality of machine learning models, a plurality of risk signals from the logs. The security application inputs the plurality of risk signals into a unified detection model and receives, as output from the unified detection model, risk classifications for a plurality of risks evident from the logs. The system determines, based on the risk classifications, at least one remedial action, and outputs a control signal instructing performance of the at least one remedial action.

### TECHNICAL FIELD

This disclosure generally relates to the field of security for electronic files, and more particularly relates to detecting threats and risk within cloud content items.

### BACKGROUND

Cloud-based content management systems such as GOOGLE DRIVE and DROPBOX have become ubiquitous for storing files for domains (e.g., companies have persons store files such as individual or collaborative documents on the content management system). Cloud storage of files comes with myriad security risks to a domain, such as accidental exposure of confidential information to the public, ease of absconding with confidential information by a bad actor, access of private information being permissioned to the wrong parties, and so on. Where administrators seek to prevent exposure of sensitive information, administrators may define broad categories that define signals corresponding to risk. However, given the trove of data and activities that occurs on cloud content items across a domain, myriad false positives are surfaced as risks, flooding administrators and obscuring true risks and threats from a sea of false positives. False positives can frustrate efforts for automated remediation of security risks as well.

### SUMMARY

Systems and methods are disclosed herein for providing an improved threat and risk detection tool, along with an improved user interface, that allows for real-time identification of risks and enables automatic remediation and/or real-time surfacing of highest risks for intervention. In an embodiment, a security application accesses logs of activity performed with respect to cloud files within the domain and determines, using a plurality of machine learning models, a plurality of risk signals from the logs. The security application inputs the plurality of risk signals into a unified detection model and receives, as output from the unified detection model, risk classifications for a plurality of risks evident from the logs. The system determines, based on the risk classifications, at least one remedial action, and outputs a control signal instructing performance of the at least one remedial action.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (FIG.) 1 illustrates one embodiment of a system environment including infrastructure for a secure communications service to detect malicious activity with respect to cloud content items for a domain, in accordance with an embodiment.

FIG. 2 illustrates exemplary modules and databases used by the secure communications service to detect the malicious activity, in accordance with an embodiment.

FIGS. 3A-3D illustrate exemplary user interfaces that are used by administrators operating a secure communications service to secure cloud-stored files of a domain, in accordance with an embodiment.

FIG. 4 is a block diagram illustrating components of an example machine able to read instructions from a machine-readable medium and execute them in a processor (or controller).

FIG. 5 depicts an illustrative flowchart having a process for detecting malicious activity with respect to cloud content items for a domain, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

FIG. 1 illustrates one embodiment of a system environment including infrastructure for a secure communications service to detect and prevent malicious activity with respect to cloud content items stored within a cloud-based content management system. As depicted in FIG. 1, environment 100 includes domain 110, network 120, secure communications service 130, and content management system 140. Domain 110 may be any environment having a plurality of users sharing a common set of security constraints. A typical domain may include users within a company sharing a domain name and sharing a team of administrators, such as an information technology team, a group of registered users within the domain, and so on. Domain 110 includes user 111 and administrator 112. While these are recited in the singular, any number of users and administrators may be part of domain 110.

User 111 may be any user operating under the security policies provided by administrator 112. User 111 may include different users subject to different security policies (e.g., different teams within a domain may be subject to different security policies; users with certain titles (e.g., executives within the company) may be subject to different security policies; etc.). User 111 may connect to domain 110 through any client device, such as a laptop, personal computer, smartphone, smart watch, or any other client device having a user interface capable of interfacing with domain 110.

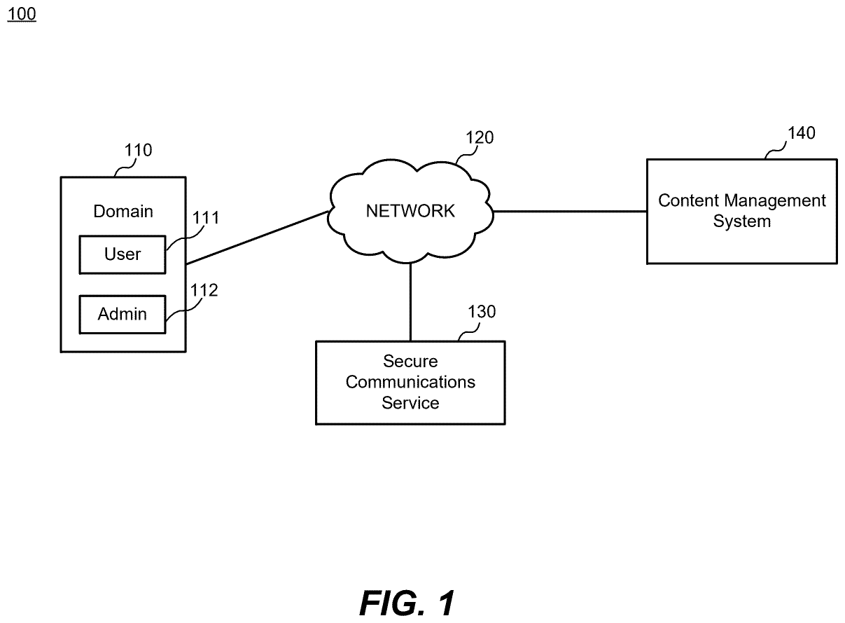

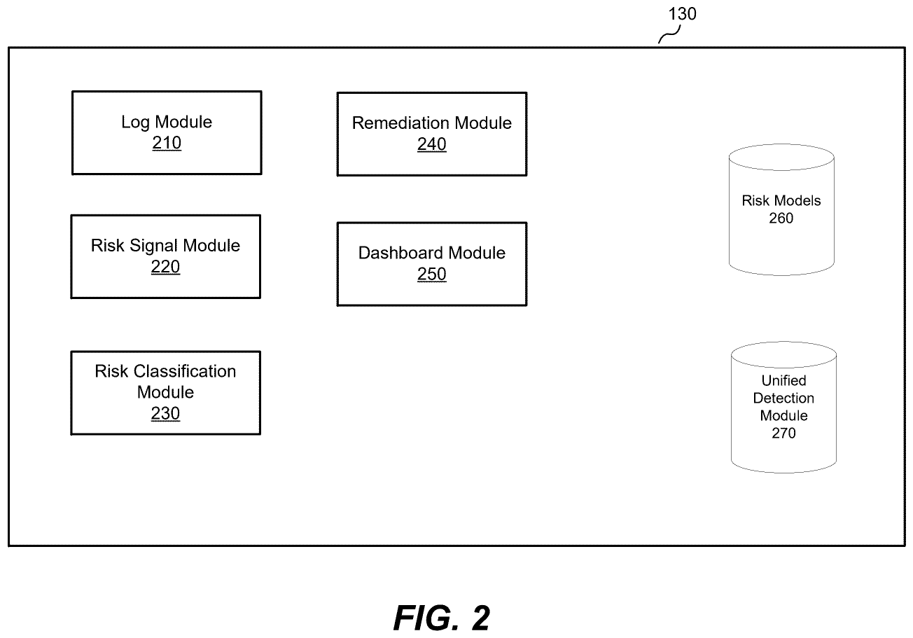

Administrator 112 may be a person having credentials to take remedial action with respect to content items within domain 110, such as files, electronic communications (e.g., instant messages, emails, text messages, and any other type of electronic communication whether or not taken through a third-party application such as SLACK or MICROSOFT TEAMS). Administrator 112 may, as described with respect to FIGS. 2-5 below, set rules to automatically detect activities with respect to cloud content items and set automatic remedial action to occur with respect to those files. Administrators themselves may have their associated cloud content items subject to rules for remediation (e.g., where there is a hierarchy in the administrators and more strict rules are applied with respect to content of administrators that are lower in the hierarchy; e.g., where security rules may apply uniformly regardless of user credentials; etc.).

Network 120 may be any network suitable for interfacing user 111 and administrator 112 to domain 110 (e.g., in scenarios where users are distributed, such as working remotely or across many office sites). Network 120 may be any network suitable for interfacing domain 110 to secure communications service 130 and/or content management system 140, and for interfacing secure communications service 130 to content management system 140. Network 120 may be any data communications channel, such as any combination of the Internet, Wi-Fi, short-range links, local area networks, and so on. Network tunneling may be used to connect any entity depicted in FIG. 1, such as virtual private network (VPN) or any other tunneling protocol.

Secure communications service 130 is a cloud service provider that provides tools to domain 110 for securing domain content stored on content management system 140. Content management system 140 is a cloud service offering secure content storage for content generated and/or stored by users of domain 110. Content management system 140 may offer permission settings for content from a domain. The permission settings may enable owners and/or authors of content to establish permissions for usage of the files. The permissions may be to access, edit, share, copy, credential permissions for other users, or perform any other function with respect to a given piece of content. Usage of content management system 140 to store files of domain 110 offers security risks. For example, private content that should not be shared outside of domain 110 may accidentally be credentialed with permissions for general public access or for access by one or more external parties. Secure communications service 130 provides tools that enable administrators of domain 110 to create rules that close security gaps in files that are stored outside of domain 110 in content management system 140. While only one content management system 140 is shown in environment 100, any number of different content management systems may be used and secure communications service 130 may generate and enforce rules across those different content management systems. Further details of secure communications service 130 and content management system 140 are described below with respect to FIGS. 2-5 below. Secure communications service 130 may be implemented on-premises at a domain, in whole are in part, rather than as a standalone cloud service provider.

FIG. 2 illustrates exemplary modules and databases used by the secure communications service to detect the malicious activity, in accordance with an embodiment. As depicted in FIG. 2, secure communications service 130 includes log module 210, risk signal module 220, risk classification module 230, remediation module 240, and dashboard module 250. Secure communications service 130 also includes risk models 260 and unified detection module 270. The modules and databases depicted in FIG. 2 are merely exemplary; fewer or more databases and/or modules may be used to achieve the functionality disclosed herein.

Log module 210 accesses logs of activity performed with respect to cloud content items within the domain. Logs may be stored by any content management system 140 used to store cloud content items for a domain and/or secure communications 130. Logs may be used to store events that are directly related to cloud content items, or have attenuated relationships (e.g., a user logs into an account within the domain, which in turn enables accessing cloud content items - the login activity may be logged). Examples of activity that directly relate to cloud content items that may be logged includes user access of files, modifications of files, creation of files, upload of files, download of files, export of files, and any other activity that involves accessing, manipulating, creating, relocating, copying, and the like with relation to a cloud content item. Examples of activity that indirectly relate or have attenuated relationships to files include accessing a system on which files are stored (e.g., log in to an enterprise), open a browser (which in turn can access cloud content items), audit logs, and so on. Log module 210 may access the logs through direct memory access, accessing the logs through an API, transferring the logs to secure communications service 130 from content management system 140 for local access, and so on.

Risk signal model 220 determines risk signals from the logs. Risk signals may be determined by monitoring for data within logs that is known to be indicative of risk. This may be done using any combination of heuristics and employing models (e.g., statistical and/or machine learning models). Heuristics may define that when certain data, alone or in combination, are considered to form a risk. For example, when logs for a user having a given credential, such as “terminated”, indicate an export of files outside of the domain, this may be defined to form a risk, even where exporting of files in generally does not form a risk.

One or more machine learning models may be trained to detect risk signals. Training examples may be used to train the machine learning models. Training examples may include collections of data as labeled with a risk indication. In some embodiments, training examples may be automatically generated as administrative users 112 identify risks. That is, where logs are associated with an event that is flagged as a risk by an administrative user 112, risk signal model 220 may generate a training example for the risk using some or all of the data within one or more logs associated with the event. Different machine learning models may be deployed to detect different risk signals. For example, for users that have certain credentials, risks may be monitored using a particular machine learning model (e.g., tuned to detect threats with respect to executives). As another example, machine learning models may be tuned to specific tasks (e.g., detecting risks for certain types of events, such as a model tuned for copying a file, versus a model tuned for exporting a file, etc.). The machine learning models may output an indication of a risk (e.g., an event, a risk classification, etc.). These indications may form risk signals (e.g., in addition to other risk signals that are extracted directly from data within logs).

In some embodiments, the machine learning models used to detect indications of risk may include one or more large language models. The large language model may be prompted with information from one or more logs, such as metadata, content within a file, etc., and where the large language model is prompted to return whether risk is present. The large language model may be primed with context for categorizing risk, and prompted to output a category of risk if risk is indeed present (e.g., phishing).

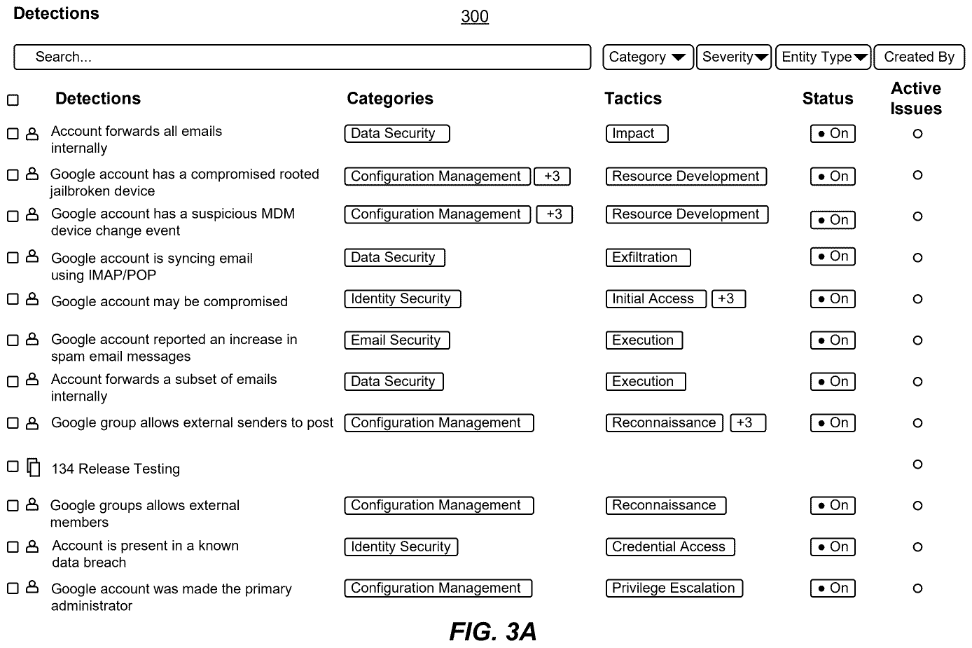

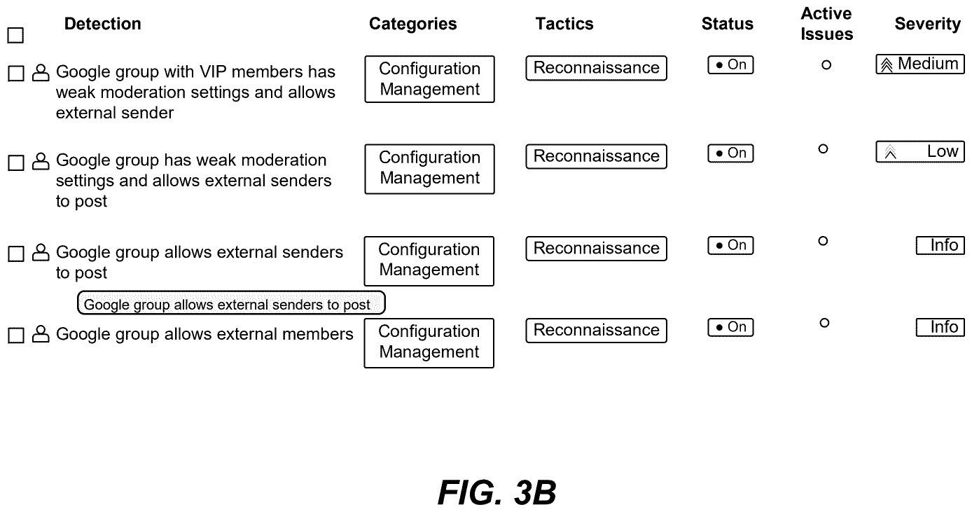

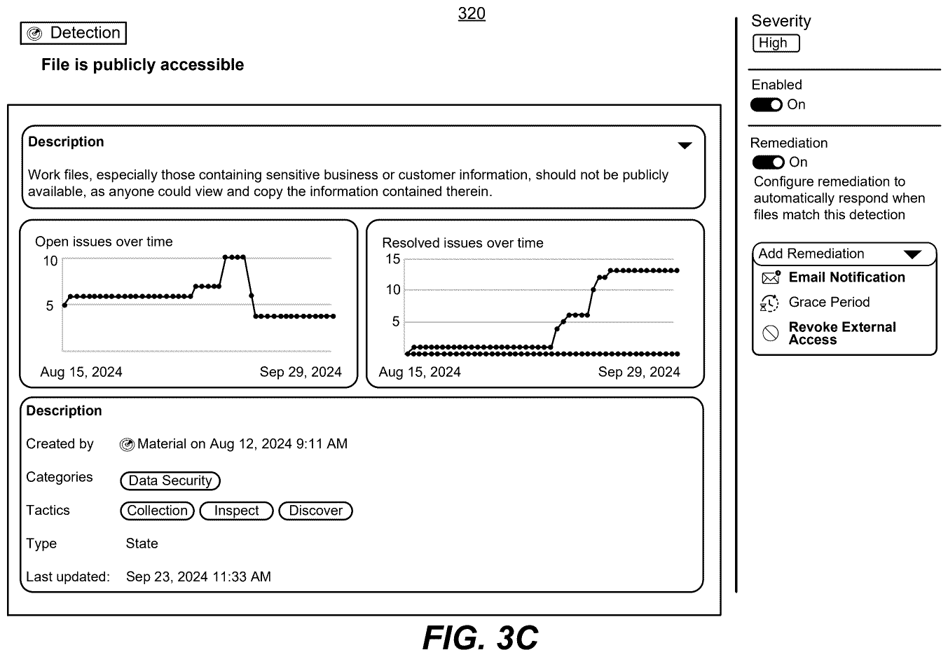

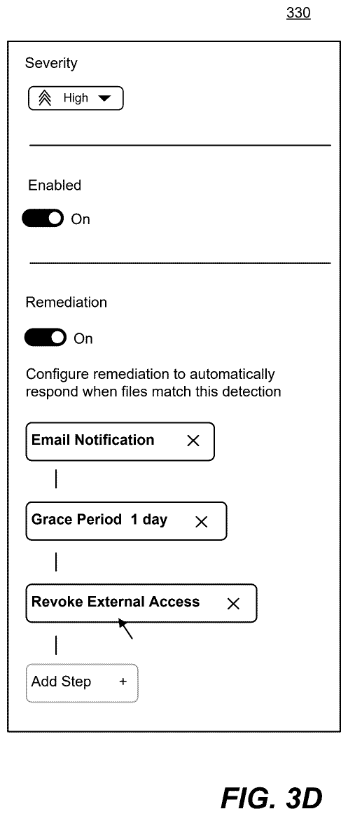

Turning briefly to FIG. 3A, FIG. 3A depicts a dashboard showing exemplary detections of risks. As an example, a detection of a risk signal may occur when any of the listed detections is observed from data within a log. A scenario, for example, where a cloud account is syncing email using IMAP/POP may form a detection, and therefore, a risk is detected by risk signal module 220 when logs indicate (e.g., through heuristics and/or machine learning models) that this has occurred. This may or may not, on its own, form an observation of a true risk on its own. Risk signals may be taken together as inputs into risk classification module 230 to determine whether, in combination, a group of risk signals merit a classification of some severity of risk.

Returning to FIG. 2, risk classification module 230 may determine risk classifications using unified detection model 270. Unified detection model 270 may include one or more machine learning models that are trained to classify collections of risk signals into risk events and to predict a risk classification for each risk event. In some embodiments, unified detection module 270 may be a supervised machine learning model. Training examples used to train the supervised machine learning model may include aggregations of risk signals labeled by a risk event and/or a risk classification. A risk event may be a categorization of a type of risk that the signals together represent (e.g., a phishing attempt, an attempt to pilfer data by an infiltrator, etc.). A risk classification may correspond to severity of the risk (e.g., low, medium, high, extreme). The training examples may be automatically generated for a domain where, as administrative users take remedial action or otherwise act with respect to a cloud content item and/or a user's account in relation to the cloud content item, collections of risk signals corresponding to that activity are labeled based on the activity taken in response. Unified detection model 270 may be and/or include heuristics and/or one or more probabilistic models to detect risk aggregations that form risk events. Any combination of supervised machine learning models, unsupervised machine learning models, probabilistic models, and/or heuristics may make up unified detection model 270.

Turning briefly to FIG. 3B, user interface 310 shows aggregate detections (e.g., a cloud group with VIP members that has email moderation settings and shows external sender activity), and a corresponding severity (e.g., medium). Risk classification module 230 thereby takes separate risk signals (e.g., cloud group, VIP members, email moderation signals, and external sender activity - each of which is a separate risk signal) and outputs a classification of a risk severity formed by these risk signals taken together.

Returning to FIG. 2, risk classification module 230 monitors for risk by inputting the risk signals into a unified detection model 270. Risk classification module 230 receives, as output from the unified detection model, risk classifications for a plurality of risks evident from the logs. In some embodiments, the risk signals input into the unified detection model 270 include attributes of a user associated with the risk event. For example, user profile information, user credential information (e.g., title, position on org chart, etc.), and/or any other user information may be included as a risk signal. This enables identification of behavior that may not be indicative of risk unless it is performed by certain types of users, in which case the activity may be determined to be anomalous. Risk classification module 230 may monitor for risk continuously, periodically, at given time intervals, and/or on any cadence.

Risk classification module 230 may retrain the unified detection model to alter its predictions for risk classification based on user interaction with respect to risk classifications. For example, risk classification module 230 may detect that an administrative user re-defines a risk classification (e.g., from medium to high, from high to low, etc.). Risk classification module 230 may re-train the machine learning model to predict a different severity when the corresponding risk event is detected in the future. Risk signals forming that event may have weights altered that cause other risk events to have different severities predicted as well. As another example, risk classification module 230 may detect that an administrative user does not take action with respect to a high severity risk, or takes action routinely with respect to particular low severity risks. Risk classification module 230 may retrain the unified detection model 270 to assign the ignored high severity risk a lower severity, or to assign the routinely addressed low-severity risks a higher severity.

Remediation module 240 instructs remediations based on identified risk classifications and/or risk events (e.g., by transmitting control signals to effect the remediations). Remediation module 240 may instruct remediations automatically and/or may instruct remediations responsive to user input requesting a remediation. To select remedial actions, remediation module may access a data structure that maps risk events and/or classifications to remedial actions to be taken responsive to detecting those scenarios. The data structure may be programmed based on input from an administrative user defining what actions to take based on given risks.

Turning briefly to FIG. 3C, user interface 320 shows a detection type of “file is publicly accessible”, though user interface 320 may be for any detection type for detecting a risk signal and/or risk event. Various information shown in graphs of user interface 320 may show incidences where this is the case. Moreover, user interface 320 may provide selectable options relating to severity, whether the detection is enabled, and automatic remediation for a risk event. The severity option may, when selected, enable an administrative user 112 to select a category associated with the risk event (e.g., low, medium, high, critical). The “enabled” option may be used by the administrative user 112 to enable or disable monitoring by risk classification module 230 for the given risk event. Remediation module 240 automatically performs defined remediations where detections are enabled and remediations are defined. The exemplary remediations depicted in FIG. 3C include options of an email notification (e.g., an email to a user to remove public access to the file by a certain deadline), and/or automatic revocation of external access to the file (e.g., immediate or time delayed).

Some remediations may instruct a device to prompt a user (e.g., domain user 111) to take corrective action responsive to detecting a risk scenario. This may include enabling security settings, disabling public access, enabling certain security steps (e.g., multi-factor authentication), proving identity, and so on. In some embodiments, remediation module 240 may monitor for the corrective action to be taken within a given range of time, and responsive to not detecting the corrective action during that time, may take a remedial action (e.g., disable access by the user, quarantine a file, etc.). Turning to FIG. 3D, user interface 330 shows more granular remediation options, where a remediation flow may be defined by an administrative user 112 having any number of steps, and time frames defined between steps. For example, an email may be provided to a user to take corrective action voluntarily, a grace period to do so of one day may be defined, and revocation of external access may then follow. Any number of steps may be defined in a remediation workflow, and remediation module 240 monitors for and enforces each step.

Dashboard module 250 outputs for display a dashboard (e.g., user interfaces 300-330). Dashboard module 250 may update the dashboard updated in real time based on periodic updates of risk classifications and ranked based on severity associated with each of the risk classifications. The dashboard is a user interface facing a technical support team for a domain, and enables administrative users to monitor for, triage, and prioritize addressing security threats. For example, highest severity risk events may be lifted to the top of the dashboard (e.g., as shown in FIG. 3B), and this may re-arrange in real time as risk events are remediated and new risk events are detected. The dashboard may be used to automate activity to be taken when certain risks are detected (e.g., as discussed with respect to FIGS. 3C-3D).

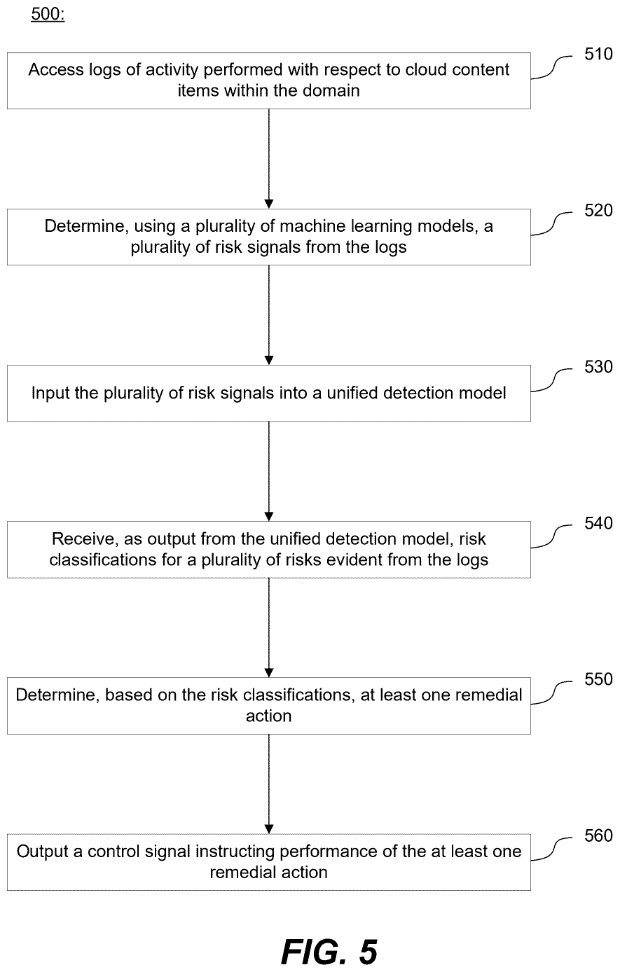

FIG. 5 depicts an illustrative flowchart having a process for detecting malicious activity with respect to cloud content items for a domain, in accordance with an embodiment. Process 500 is executed by one or more processors executing computer readable instructions that, when executed, cause modules of secure communications service 130 to perform steps of the process. Process 500 begins with secure communications service 130 accessing 510 logs of activity performed with respect to cloud content items within the domain (e.g., using log module 210). Secure communications service 130 determines 520, using a plurality of machine learning models, a plurality of risk signals from the logs (e.g., using risk signal module 220).

Secure communications service 130 inputs 530 the plurality of risk signals into a unified detection model, and receives 540, as output from the unified detection model, risk classifications for a plurality of risks evident from the logs (e.g., using risk classification module 230). Secure communications service 130 determines 550, based on the risk classifications, at least one remedial action, and outputs 560 a control signal instructing performance of the at least one remedial action.

### Computing Machine Architecture

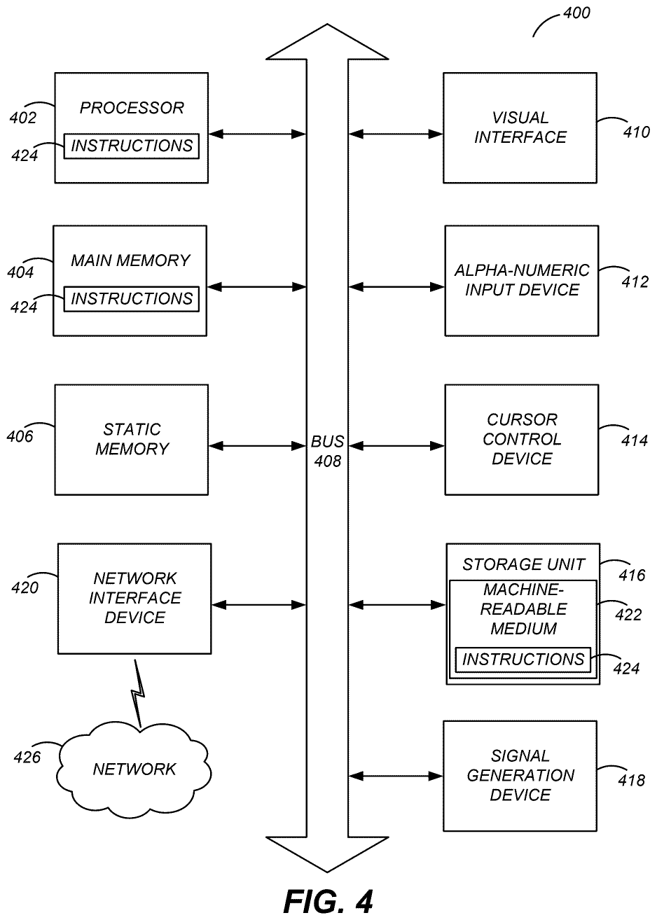

FIG. (Figure) 4 is a block diagram illustrating components of an example machine able to read instructions from a machine-readable medium and execute them in a processor (or controller, or one or more of the same). Specifically, FIG. 4 shows a diagrammatic representation of a machine in the example form of a computer system 400 within which program code (e.g., software, including the modules described herein) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for enforcing security in cloud content items for a domain through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for identifying security vulnerabilities within a domain, the method comprising:
accessing logs of activity performed with respect to cloud content items within the domain;
determining, using a plurality of machine learning models, a plurality of risk signals from the logs;
inputting the plurality of risk signals into a unified detection model;
receiving, as output from the unified detection model, risk classifications for a plurality of risks evident from the logs;
determining, based on the risk classifications, at least one remedial action; and
outputting a control signal instructing performance of the at least one remedial action.

2. The method of claim 1, wherein the logs of activity performed with respect to cloud content items within the domain comprise activity records with respect to transferring one or more of the cloud content items.

3. The method of claim 2, wherein the plurality of machine learning models comprises a large language model configured to classify messages according to a plurality of candidate malicious activities.

4. The method of claim 1, wherein the unified detection model is trained to classify collections of risk signals into risk events and to predict a risk classification for each risk event.

5. The method of claim 4, wherein classifying the collections of risk signals into risk events comprises determining a risk event at least partially based on attributes of a user associated with the risk event.

6. The method of claim 5, wherein determining the risk event comprises determining an anomalous collection of risk signals with respect to the user.

7. The method of claim 1, further comprising outputting for display a dashboard, the dashboard updated in real time based on periodic updates of risk classifications and ranked based on severity associated with each of the risk classifications.

8. The method of claim 1, wherein the control signal comprises an instruction to prompt a user to take corrective action.

9. The method of claim 8, further comprising:
monitoring for the corrective action for a given range of time; and
responsive to not detecting the corrective action during the given range of time, performing the at least one remedial action.

10. A non-transitory computer-readable medium comprising memory with instructions encoded thereon that, when executed by one or more processors, causes the one or more processors to perform operations, the instructions comprising instructions to:
access logs of activity performed with respect to cloud content items within a domain;
determine, using a plurality of machine learning models, a plurality of risk signals from the logs;
input the plurality of risk signals into a unified detection model;
receive, as output from the unified detection model, risk classifications for a plurality of risks evident from the logs;
determine, based on the risk classifications, at least one remedial action; and
output a control signal instructing performance of the at least one remedial action.

11. The non-transitory computer-readable medium of claim 10, wherein the logs of activity performed with respect to cloud content items within the domain comprise activity records with respect to transferring one or more of the cloud content items.

12. The non-transitory computer-readable medium of claim 11, wherein the plurality of machine learning models comprises a large language model configured to classify messages according to a plurality of candidate malicious activities.

13. The non-transitory computer-readable medium of claim 10, wherein the unified detection model is trained to classify collections of risk signals into risk events and to predict a risk classification for each risk event.

14. The non-transitory computer-readable medium of claim 13, wherein the instructions to classify the collections of risk signals into risk events comprise instructions to determine a risk event at least partially based on attributes of a user associated with the risk event.

15. The non-transitory computer-readable medium of claim 14, wherein the instructions to determine the risk event comprise instructions to determine an anomalous collection of risk signals with respect to the user.

16. The non-transitory computer-readable medium of claim 10, the instructions further comprising instructions to output for display a dashboard, the dashboard updated in real time based on periodic updates of risk classifications and ranked based on severity associated with each of the risk classifications.

17. The non-transitory computer-readable medium of claim 10, wherein the control signal comprises an instruction to prompt a user to take corrective action.

18. The non-transitory computer-readable medium of claim 17, the instructions further comprising instructions to:
monitor for the corrective action for a given range of time; and
responsive to not detecting the corrective action during the given range of time, perform the at least one remedial action.

19. A system comprising:
memory with instructions encoded thereon; and
one or more processors that, when executing the instructions, are caused to perform operations comprising:
accessing logs of activity performed with respect to cloud content items within a domain;
determining, using a plurality of machine learning models, a plurality of risk signals from the logs;
inputting the plurality of risk signals into a unified detection model;
receiving, as output from the unified detection model, risk classifications for a plurality of risks evident from the logs;
determining, based on the risk classifications, at least one remedial action; and
outputting a control signal instructing performance of the at least one remedial action.

20. The system of claim 19, wherein the logs of activity performed with respect to cloud files within the domain comprise activity records with respect to transferring one or more of the cloud files.
